(19) United States
(12) Patent Application Publication
(10) Pub. No.: US 2026/0369635 A1
(43) Pub. Date: Nov. 19, 2026

(54) SECONDARY BATTERY

(71) Applicant: Standard Energy Inc., Daejeon (KR)

(72) Inventors: Dongyoung LEE, Daejeon (KR); Sanghyun PARK, Daejeon (KR)

(73) Assignee: Standard Energy Inc., Daejeon (KR)

(21) Appl. No.: 19/476,004

(22) PCT Filed: Apr. 18, 2024
(86) PCT No.: PCT/KR2024/005248

§ 371 Date: Oct. 16, 2025

(30) Foreign Application Priority Data
Apr. 21, 2023 (KR) 10-2023-0052432

(51) Int. Cl. H01M 8/04186; H01M 8/0247; H01M 8/18; H01M 8/2455

(52) U.S. Cl. CPC H01M 8/04186; H01M 8/0247; H01M 8/188; H01M 8/2455

(57) ABSTRACT

A secondary battery includes: a plurality of monoblocs and a multi-busbar. Each of the plurality of monoblocs includes a plurality of layers stacked in one direction in which redox reactions occur. The multi-busbar is configured to connect the plurality of monoblocs in series and connect the plurality of layers of each of the plurality of monoblocs in parallel.

### CROSS-REFERENCE TO PRIOR APPLICATIONS

This Application is a National Stage Patent Application of PCT International Application No. PCT/KR2024/005248 (filed on Apr. 18, 2024), which claims priority to Korean Patent Application No. 10-2023-0052432 (filed on Apr. 21, 2023), which are all hereby incorporated by reference in their entirety.

### BACKGROUND

The present disclosure relates to a secondary battery and a manufacturing method thereof. More specifically, the present disclosure relates to a secondary battery in which metal ions dissolved in an electrolyte undergo oxidation-reduction to charge and discharge the battery.

Unlike existing secondary batteries, a redox secondary battery is a system in which an active material in the electrolyte undergoes oxidation-reduction to charge and discharge the battery, and is an electrochemical storage device that stores electrical energy as chemical energy of an electrolyte solution. A conventional redox flow battery operates by continuously circulating the electrolyte in a tank inside a stack using a pump and causing electrochemical reactions in the stack. Such redox flow batteries have spatial constraints and design difficulties due to the tank and pump. The inventors of the present disclosure have developed a redox secondary battery that eliminates the tank and pump. However, to increase energy storage capacity, multiple stacks must be used, and accordingly, efficient electrical connection of multiple stacks has been required.

### SUMMARY

A purpose of the present disclosure is to provide a secondary battery in which efficient electrical connection between a plurality of monoblocs (stacks) is achieved.

Purposes according to the present disclosure are not limited to the above-mentioned purpose. Other purposes and advantages according to the present disclosure that are not mentioned may be understood based on the following descriptions, and may be more clearly understood based on embodiments according to the present disclosure.

To achieve the above purpose, a secondary battery according to an embodiment of the present disclosure comprises, a plurality of monoblocs, wherein each of the plurality of monoblocs comprises a plurality of layers stacked in one direction in which redox reactions occur; and a multi-busbar to connect the plurality of monoblocs in series and connect the plurality of layers of each of the plurality of monoblocs in parallel.

Details of other embodiments are included in the detailed description and drawings.

According to the secondary battery of the present disclosure, there are one or more of the following effects.

First, there is an advantage of increased energy efficiency and high power capability by electrically connecting a plurality of layers and electrically connecting a plurality of monoblocs with a single multi-busbar.

Second, there is also an advantage of reducing the overall weight and volume of the secondary battery by using a relatively thin multi-busbar.

Third, there is also an advantage of improved welding process for electrical connection.

The effects of the present disclosure are not limited to the effects mentioned above, and other effects not mentioned will be clearly understood by those skilled in the art from the description of the claims.

### BRIEF DESCRIPTION OF THE DRAWINGS

FIG. 1 is a perspective view of a secondary battery according to an embodiment of the present disclosure.

FIG. 2 is a plan view of a secondary battery according to an embodiment of the present disclosure.

FIG. 3 is a partial exploded view of a secondary battery according to an embodiment of the present disclosure.

FIG. 4 is an exploded view of a layer of a secondary battery according to an embodiment of the present disclosure.

FIG. 5 is a cross-sectional view of a layer of a secondary battery according to an embodiment of the present disclosure.

FIG. 6 is an assembly process diagram of a secondary battery according to an embodiment of the present disclosure.

### DETAILED DESCRIPTION

Advantages and features of the present disclosure, and methods of achieving them will become apparent with reference to embodiments described later in detail together with the accompanying drawings. However, the present disclosure is not limited to the embodiments disclosed below, but may be embodied in various different forms. These embodiments are provided only to make the disclosure of the present disclosure complete, and to completely inform the scope of the invention to those of ordinary skill in the technical field to which the present disclosure belongs. The present disclosure is only defined by the scope of the claims. The same reference numbers refer to the same components throughout the specification.

Although first, second, etc. are used to describe various components, these components are not limited by these terms, of course. These terms are used only to distinguish one component from another component. Unless specifically stated otherwise, a first component may be a second component, of course.

Throughout the specification, unless specifically stated otherwise, each component may be singular or plural.

In the following, when any configuration is disposed on the “top (or bottom)” of a component or on “above (or below)” a component, this may mean not only that any configuration is disposed in contact with the top surface (or bottom surface) of the component, but also that another configuration may be interposed between the component and any configuration disposed on (or under) the component.

Also, when a component is described as being “connected,” “coupled,” or “connected” to another component, the components may be directly connected or connected to each other, but it should be understood that another component may be “interposed” between each component, or each component may be “connected,” “coupled,” or “connected” through another component.

The singular expression used in this specification includes the plural expression unless the context clearly indicates otherwise. In this application, terms such as “configured” or “comprises” should not be interpreted as necessarily including all of the various components or various steps described in the specification. Some components or some steps may not be included, or additional components or steps may be further included.

Throughout the specification, when referring to “A and/or B,” unless specifically stated otherwise, it means A, B, or A and B, and when referring to “C to D,” unless specifically stated otherwise, it means C or more and D or less.

Hereinafter, the present disclosure will be described with reference to drawings for explaining a secondary battery according to embodiments of the present disclosure.

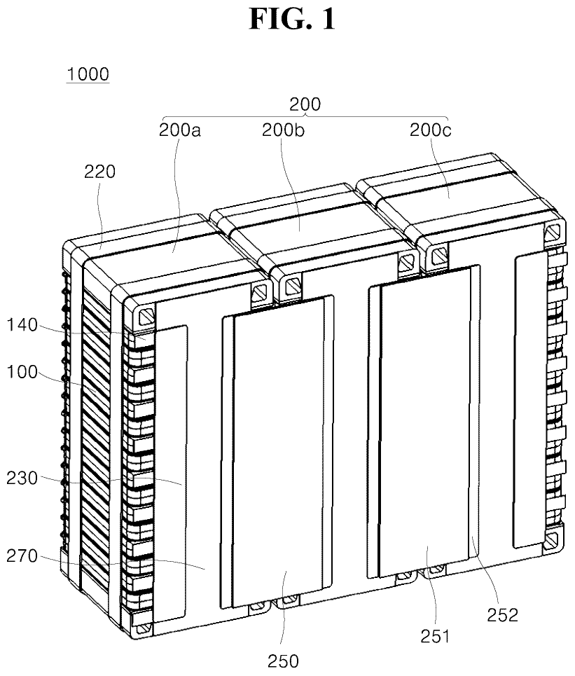

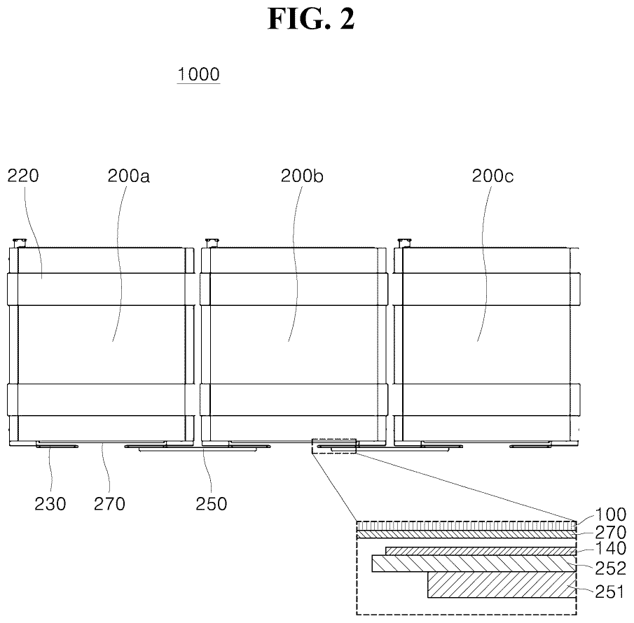

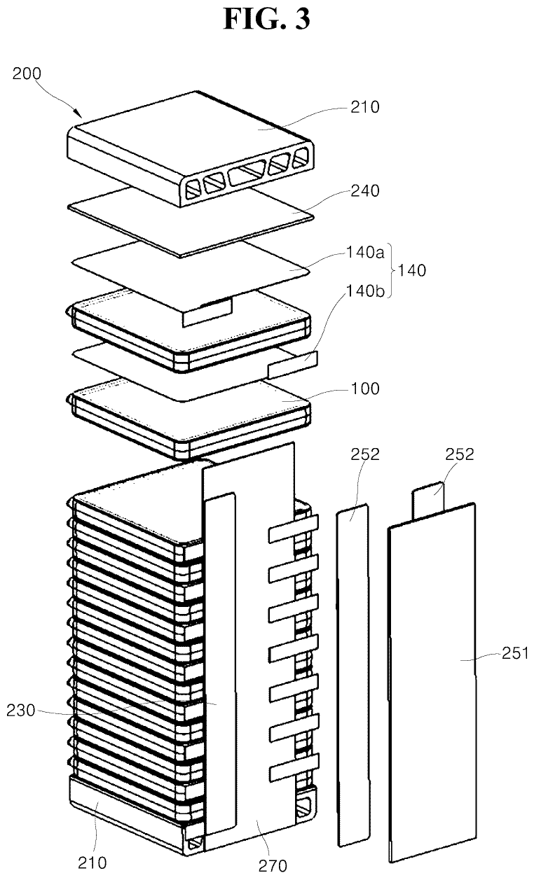

FIG. 1 is a perspective view of a secondary battery according to an embodiment of the present disclosure, FIG. 2 is a plan view of a secondary battery according to an embodiment of the present disclosure, and FIG. 3 is a partial exploded view of a secondary battery according to an embodiment of the present disclosure.

A secondary battery 1000 according to an embodiment of the present disclosure comprises, a plurality of monoblocs 200; a multi-busbar 250 to connects at least two of the plurality of monoblocs 200 in series and connect the plurality of layers 100 of each of the plurality of monoblocs 200 connected in series in parallel; and a single-busbar 230 to connect the plurality of layers 100 of any one of the plurality of monoblocs 200 in parallel.

In the secondary battery 1000, two or more monoblocs 200 are arranged densely in a horizontal direction (a direction perpendicular to the stacking direction of the plurality of layers 100), and in this embodiment, three monoblocs 200 are arranged. In this embodiment, the plurality of monoblocs 200 consists of a first monobloc 200a, a second monobloc 200b, and a third monobloc 200c.

Each of the plurality of monoblocs 200 has a rectangular parallelepiped shape elongated in a height direction (stacking direction of the plurality of layers 100). Each of the plurality of monoblocs 200 comprises, a plurality of layers 100 in which redox reactions occur and which are stacked in one direction; a pair of end plates 210 respectively disposed at both ends in the stacking direction of the layers 100; a band 220 to wrap and fasten the pair of end plates 210 and the plurality of layers 100; and a protective plate 270 disposed between the plurality of layers 100 and the multi-busbar 250 and/or single-busbar 230.

In the layer 100, redox couples dissolved in the electrolyte undergo redox reactions to accumulate or release electrical energy. The layer 100 has a rectangular parallelepiped shape with a small height. The plurality of layers 100 are stacked in the height direction. It is preferable that the plurality of layers 100 stacked in the height direction have a rectangular parallelepiped shape with a large height.

A pair of end plates 210 are disposed at both ends in the stacking direction (height direction) of the stacked plurality of layers 100. Each of the pair of end plates 210 has a rectangular parallelepiped shape with a small height. The end plate 210 has a band 220 disposed on both opposing side surfaces and one base. The end plate 210 is formed with rounded edges at two corners where the band 220 contacts. The end plate 210 may be formed of a material containing high-strength inorganic materials, and may be an insulation-coated metal or a mixture containing cement.

A pair of insulating plates 240 may be disposed between the stacked plurality of layers 100 and the pair of end plates 210, respectively. Each of the pair of insulating plates 240 is preferably made of a non-conductive material with high strength, excellent heat resistance and chemical resistance, and in this embodiment is an acrylic resin.

The plurality of layers 100 are fastened together with the pair of end plates 210 by the band 220. The band 220 wraps and fastens the pair of end plates 210 and the plurality of layers 100. The band 220 is formed in a ring shape and is disposed to wrap around the pair of end plates 210 and both side surfaces of the plurality of layers 100. The band 220 is disposed on both side surfaces of the plurality of layers 100 on which the multi-busbar 250 is not disposed. The band 220 physically connects the plurality of layers 100 and the pair of end plates 210 (and the pair of insulating plates 240). The band 220 is made of PP (polypropylene) or PET (polyethylene terephthalate) material with low elasticity, non-conductivity, and excellent heat and chemical resistance.

The band 220 may be provided in plurality. The plurality of bands 220 are spaced apart from each other and arranged in parallel to wrap and fasten the pair of end plates 210 and the plurality of layers 100 in the same direction.

The protective plate 270 is disposed on the side surface of the plurality of layers 100 to protect the plurality of layers 100 from the multi-busbar 250 and/or single-busbar 230. The protective plate 270 insulates and thermally isolates the multi-busbar 250 and/or single-busbar 230 from the plurality of layers 100. The protective plate 270 protects the plurality of layers 100 during welding of the multi-busbar 250 and/or single-busbar 230 with the plurality of metal current collectors 140. The protective plate 270 preferably has a height greater than that of the multi-busbar 250 or single-busbar 230. The protective plate 270 is preferably made of a non-conductive material with high strength, excellent heat resistance and chemical resistance, and in this embodiment is an acrylic resin.

The multi-busbar 250 connects adjacent plurality of monoblocs 200 in series and connects the plurality of layers 100 of each of the plurality of monoblocs 200 connected in series in parallel. In this embodiment, the multi-busbar 250 connects two monoblocs 200 in series and connects the plurality of layers 100 of each of the two monoblocs 200 connected in series in parallel.

In this embodiment, two multi-busbars 250 are provided. One of the two multi-busbars 250 connects the plurality of layers 100 of the first monobloc 200a in parallel, connects the plurality of layers 100 of the second monobloc 200b in parallel, and connects the first monobloc 200a and the second monobloc 200b in series. In this embodiment, the other multi-busbar 250 of the two multi-busbars 250 connects the plurality of layers 100 of the second monobloc 200b in parallel, connects the plurality of layers 100 of the third monobloc 200c in parallel, and connects the second monobloc 200b and the third monobloc 200c in series.

The multi-busbar 250 has a rectangular plate shape elongated in the height direction. The multi-busbar 250 may have a height greater than or approximately equal to the height of the stacked plurality of layers 100.

The multi-busbar 250 is disposed on the same side surface of the plurality of layers 100 of each of the plurality of monoblocs 200. The multi-busbar 250 is disposed on the same side surface of the plurality of monoblocs 200.

The multi-busbar 250 is disposed on the side surface of the plurality of layers 100 on which the band 220 is not disposed. The multi-busbar 250 is disposed on the side surface of the plurality of layers 100 (side surface of the monobloc 200) on which the single-busbar 230 is disposed.

The multi-busbar 250 electrically connects some of the plurality of metal current collectors 140 of each of the plurality of monoblocs 200. Others of the plurality of metal current collectors 140 of each of the plurality of monoblocs 200 which are not connected to the multi-busbar 250 are connected by the single-busbar 230 or electrically connected by another multi-busbar 250.

The multi-busbar 250 electrically connects the plurality of second metal current collectors 140b of one of the plurality of monoblocs 200 and electrically connects the first metal current collectors 140a of another of the plurality of monoblocs 200.

Referring to FIGS. 1 to 3, one multi-busbar 250 of the two multi-busbars 250 electrically connects the plurality of second metal current collectors 140b of the first monobloc 200a and electrically connects the plurality of first metal current collectors 140a of the second monobloc 200b.

The other multi-busbar 250 of the two multi-busbars 250 electrically connects the plurality of second metal current collectors 140b of the second monobloc 200b and electrically connects the plurality of first metal current collectors 140a of the third monobloc 200c.

The single-busbar 230 connects the plurality of layers 100 of at least one of the plurality of monoblocs 200 in parallel. The single-busbar 230 connects the plurality of layers 100 of the monoblocs 200 disposed at both ends in the horizontal direction among the plurality of monoblocs 200 arranged densely in the horizontal direction in parallel. In this embodiment, one single-busbar 230 electrically connects the plurality of first metal current collectors 140a of the first monobloc 200a, and another single-busbar 230 electrically connects the plurality of second metal current collectors 140b of the third monobloc 200c.

The single-busbar 230 electrically connects the plurality of first metal current collectors 140a of the monobloc 200 in which the plurality of second metal current collectors 140b are connected in parallel by the multi-busbar 250.

The single-busbar 230 has a rectangular plate shape elongated in the height direction. The single-busbar 230 may have a height greater than or approximately equal to the height of the stacked plurality of layers 100.

The single-busbar 230 and the multi-busbar 250 are disposed on the same side surface of each of the plurality of monoblocs 200. The single-busbar 230 and the multi-busbar 250 preferably have the same height.

The multi-busbar 250 comprises, a pair of multi-busbar wings 252; and a multi-busbar body 251 joined to the pair of multi-busbar wings 252. Each of the pair of multi-busbar wings 252 connects the plurality of layers 100 of each of the plurality of monoblocs 200 in parallel. The multi-busbar body 251 electrically connects the pair of multi-busbar wings 252 to connect the plurality of monoblocs 200 in series.

The multi-busbar body 251 has a rectangular plate shape elongated in the height direction, and each of the pair of multi-busbar wings 252 has a rectangular plate shape elongated in the height direction. Each of the pair of multi-busbar wings 252 has the same height as the multi-busbar body 251, but has a width narrower than the width of the multi-busbar body 251. Each of the pair of multi-busbar wings 252 has a thickness thinner than the multi-busbar body 251. The pair of multi-busbar wings 252 preferably have a relatively thin thickness for easy welding, and the multi-busbar body 251 preferably has a relatively thick thickness for high conductivity.

The pair of multi-busbar wings 252 are joined to both sides of the multi-busbar body 251. Each of the pair of multi-busbar wings 252 has one portion overlapped and joined with the multi-busbar body 251, and another portion not overlapped with the multi-busbar body 251 is joined with some of the plurality of metal current collectors 140 of the plurality of layers 100. Each of the pair of multi-busbar wings 252 has one surface joined to the multi-busbar body 251, and the other surface joined to some of the plurality of metal current collectors 140.

Referring to FIG. 2, based on the horizontal direction, the metal current collector 140, the multi-busbar wing 252, and the multi-busbar body 251 are sequentially stacked. Based on one direction of the horizontal directions, the multi-busbar wing 252 is joined to the front surface of the metal current collector 140, and the multi-busbar body 251 is joined to the front surface of the multi-busbar wing 252.

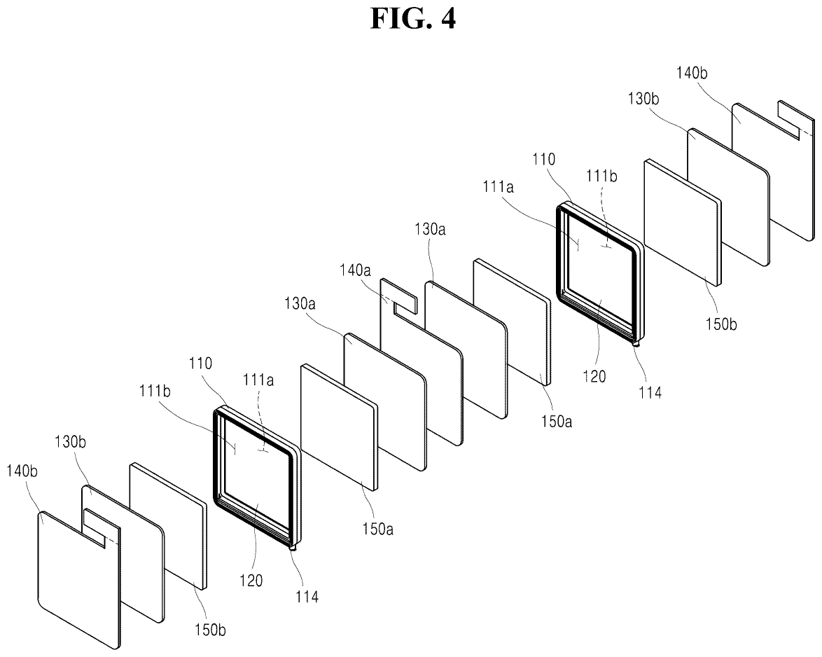

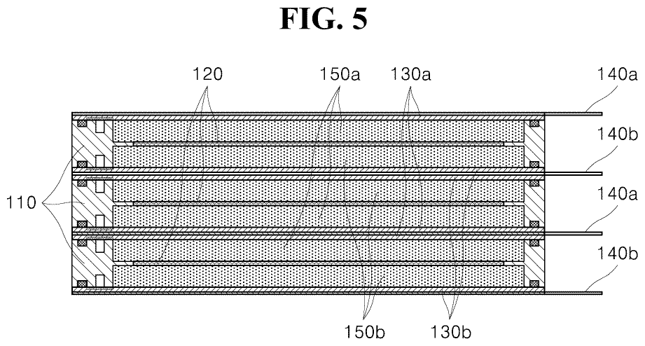

FIG. 4 is an exploded view of a layer of a secondary battery according to an embodiment of the present disclosure, and FIG. 5 is a cross-sectional view of a layer of a secondary battery according to an embodiment of the present disclosure.

The layer 100 comprises, a first liquid electrode where a first half reaction occurs; a second liquid electrode where a second half reaction occurs; a hollow frame 110 forming a first electrode reservoir 111a as a space where the first liquid electrode is stored and a second electrode reservoir 111b as a space where the second liquid electrode is stored; a separator 120 coupled to the frame 110 and disposed between the first electrode reservoir 111a and the second electrode reservoir 111b; a first carbon current collector 130a in contact with the first electrode reservoir 111a side of the frame 110 and electrically connected to the first liquid electrode; a second carbon current collector 130b in contact with the second electrode reservoir 111b side of the frame 110 and electrically connected to the second liquid electrode; a first metal current collector 140a in contact with the first carbon current collector 130a and electrically connected to the first carbon current collector 130a; a second metal current collector 140b in contact with the second carbon current collector 130b and electrically connected to the second carbon current collector 130b; a first solid electrode 150a disposed in the first electrode reservoir 111a and impregnated with the first liquid electrode; and a second solid electrode 150b disposed in the second electrode reservoir 111b and impregnated with the second liquid electrode.

The first liquid electrode is an electrolyte in which an anode redox couple is dissolved. The anode redox couple may be implemented with materials including at least one of vanadium (V), zinc (Zn), bromine (Br), chromium (Cr), manganese (Mn), titanium (Ti), iron (Fe), cerium (Ce), and cobalt (Co), and in this embodiment is a V²⁺/V³⁺ redox couple. The first liquid electrode may be an acidic aqueous solution that conducts current through ionization, and preferably contains sulfuric acid. In this embodiment, the first liquid electrode may be prepared by dissolving VOSO₄ (vanadylsulfate) or V₂O₅ (vanadium pentoxide) in H₂SO₄ aqueous solution.

The first liquid electrode causes the first half reaction. The first half reaction is as follows, where → indicates the discharge reaction direction and ← indicates the charge reaction direction.

V²⁺←→V³⁺+e⁻

During discharge, divalent vanadium ions are oxidized to trivalent vanadium ions, and during charging, trivalent vanadium ions are reduced to divalent vanadium ions.

The first liquid electrode is surrounded by the frame 110, the first carbon current collector 130a, and the separator 120. The first liquid electrode is impregnated in the first solid electrode 150a and accommodated in the first electrode reservoir 111a.

The first liquid electrode is electrically connected to the first carbon current collector 130a, so that electrons move to the first carbon current collector 130a during discharge, and electrons from the first carbon current collector 130a move to the first liquid electrode during charging. The first liquid electrode is in contact with the separator 120 so that hydrogen cations (protons) are transferred through the separator 120.

The second liquid electrode is an electrolyte in which a cathode redox couple is dissolved. The cathode redox couple may be implemented with materials including at least one of vanadium (V), zinc (Zn), bromine (Br), chromium (Cr), manganese (Mn), titanium (Ti), iron (Fe), cerium (Ce), and cobalt (Co), and in this embodiment is a V⁴⁺/V⁵⁺ redox couple. The second liquid electrode may be an acidic aqueous solution that conducts current through ionization, and preferably contains sulfuric acid. In this embodiment, the second liquid electrode may be prepared by dissolving VOSO₄ (vanadylsulfate) or V₂O₅ (vanadium pentoxide) in H₂SO₄ aqueous solution.

The second liquid electrode causes the second half reaction. The second half reaction is as follows, where → indicates the discharge reaction direction and ← indicates the charge reaction direction.

V⁵⁺+e⁻←→V⁴⁺

During discharge, pentavalent vanadium ions are reduced to tetravalent vanadium ions, and during charging, tetravalent vanadium ions are oxidized to pentavalent vanadium ions.

The second liquid electrode is surrounded by the frame 110, the second carbon current collector 130b, and the separator 120. The second liquid electrode is impregnated in the second solid electrode 150b and accommodated in the second electrode reservoir 111b.

The second liquid electrode is electrically connected to the second carbon current collector 130b, so that electrons move to the second carbon current collector 130b during charging, and electrons from the second carbon current collector 130b move to the second liquid electrode during discharge. The second liquid electrode is in contact with the separator 120 so that hydrogen cations (protons) are transferred through the separator 120.

As described above, the first liquid electrode and the second liquid electrode have the same composition. The first liquid electrode and the second liquid electrode are electrolytes of the same composition containing vanadium ions. When manufacturing the secondary battery, when an electrolyte in which 3.5-valent vanadium ions (V^{3.5+}) are dissolved is injected into the first electrode reservoir 111a and the second electrode reservoir 111b, the liquid electrode flowing into the first electrode reservoir 111a becomes the first liquid electrode and the liquid electrode flowing into the second electrode reservoir 111b becomes the second liquid electrode.

The frame 110 is formed as a hollow hexahedron. The frame 110 is preferably a rectangular parallelepiped with open upper and lower surfaces and low height. According to embodiments, the frame 110 may be formed as polyhedra of various shapes. The frame 110 forms the first electrode reservoir 111a and the second electrode reservoir 111b. The frame 110 has an injection port 114 through which the first liquid electrode is injected into the first electrode reservoir 111a and the second liquid electrode is injected into the second electrode reservoir 111b.

The hollow space of the frame 110 is divided into the first electrode reservoir 111a and the second electrode reservoir 111b by the separator 120. The separator 120 is coupled to the center of the frame 110 in the height direction (stacking direction of the plurality of layers 100). The frame 110 supports the separator 120.

The frame 110 has the first carbon current collector 130a disposed on one side in the height direction and the second carbon current collector 130b disposed on the other side. The hollow of the frame 110 is closed by the first carbon current collector 130a and the second carbon current collector 130b. The frame 110 forms the first electrode reservoir 111a between the first carbon current collector 130a and the separator 120, and forms the second electrode reservoir 111b between the second carbon current collector 130b and the separator 120. The frame 110 accommodates the first liquid electrode and the second liquid electrode. The first solid electrode 150a and the second solid electrode 150b are disposed inside the frame 110.

The separator 120 is disposed inside the frame 110 to separate the first liquid electrode and the second liquid electrode and allow hydrogen cations (protons) to move between the first liquid electrode and the second liquid electrode. The separator 120 is disposed inside the frame 110 to distinguish the first electrode reservoir 111a and the second electrode reservoir 111b. The separator 120 is disposed between the first carbon current collector 130a and the second carbon current collector 130b. The edge of the separator 120 is coupled to the frame 110. Hydrogen cations move from the first liquid electrode to the second liquid electrode through the separator 120 during discharge, and move from the second liquid electrode to the first liquid electrode through the separator 120 during charging.

The separator 120 may include perfluorinated ionomer, partially fluorinated polymer, and non-fluorinated hydrocarbons. The separator 120 may be formed of or include Nafion®, Flemion®, NEOSEPTA-F®, or Gore Select®.

The first carbon current collector 130a is disposed on one side of the frame 110 and forms the first electrode reservoir 111a together with the frame 110 and the separator 120. The first carbon current collector 130a is electrically connected to the first liquid electrode, and electrons move during charging and discharging.

The first carbon current collector 130a is formed of materials such as graphite, carbon, and carbon plastic, and has high electrical conductivity and high acid resistance. The first carbon current collector 130a is disposed between the first liquid electrode and the first metal current collector 140a to allow electrons to move between them, but prevents the first metal current collector 140a from being oxidized by the liquid electrode.

When the plurality of layers 100 are stacked, two first carbon current collectors 130a of two adjacent layers 100 are disposed adjacent to each other. One first metal current collector 140a is disposed between two adjacent first carbon current collectors 130a.

The second carbon current collector 130b is disposed on one side of the frame 110 and forms the second electrode reservoir 111b together with the frame 110 and the separator 120. The second carbon current collector 130b is electrically connected to the second liquid electrode, and electrons move during charging and discharging.

The second carbon current collector 130b is formed of materials such as graphite, carbon, and carbon plastic, and has high electrical conductivity and high acid resistance. The second carbon current collector 130b is disposed between the second liquid electrode and the second metal current collector 140b to allow electrons to move between them, but prevents the second metal current collector 140b from being oxidized by the liquid electrode.

When the plurality of layers 100 are stacked, two second carbon current collectors 130b of two adjacent layers 100 are disposed adjacent to each other. One second metal current collector 140b is disposed between two adjacent second carbon current collectors 130b.

The first metal current collector 140a is formed of a metal with high electrical conductivity, for example, copper or aluminum. The first metal current collector 140a may be formed as a flexible thin film or as a rigid plate. The first metal current collector 140a is formed in a rectangular plate shape with a portion protruding to the side surface of the layer 100 and connected to the multi-busbar 250 or single-busbar 230 which connects the plurality of layers 100 in parallel.

The first metal current collector 140a is in surface contact with the first carbon current collector 130a and is electrically connected. The first metal current collector 140a allows electrons to move by the redox reaction of the first liquid electrode, causing current to flow.

The first metal current collector 140a is disposed between two adjacent first carbon current collectors 130a or between the first carbon current collector 130a and the end plate 210 (or insulating plate 240). When the plurality of layers 100 are stacked, any two adjacent layers 100 include one first metal current collector 140a.

The second metal current collector 140b is formed of a metal with high electrical conductivity, for example, copper or aluminum. The second metal current collector 140b may be formed as a flexible thin film or as a rigid plate. The second metal current collector 140b is formed in a rectangular plate shape with a portion protruding to the side surface of the layer 100 and connected to the multi-busbar 250 or single-busbar 230 which connects the plurality of layers 100 in parallel.

The second metal current collector 140b is in surface contact with the second carbon current collector 130b and is electrically connected. The second metal current collector 140b allows electrons to move by the redox reaction of the second liquid electrode, causing current to flow.

The second metal current collector 140b is disposed between two adjacent second carbon current collectors 130b or between the second carbon current collector 130b and the end plate 210 (or insulating plate 240). When the plurality of layers 100 are stacked, any two adjacent layers 100 include one second metal current collector 140b.

The first metal current collector 140a and the second metal current collector 140b described above are made of the same material and have the same shape, and are collectively referred to as metal current collector 140. Among the plurality of metal current collectors 140, those in contact with the first carbon current collector 130a become the first metal current collector 140a, and those in contact with the second carbon current collector 130b become the second metal current collector 140b. When placing the first metal current collector 140a and the second metal current collector 140b of the same shape, one of them is flipped so that the portions connected to the multi-busbar 250 or single-busbar 230 are arranged differently.

When the plurality of layers 100 are stacked, any two adjacent layers 100 include one metal current collector 140. When the plurality of layers 100 are stacked, the plurality of metal current collectors 140 are disposed one by one between two adjacent first carbon current collectors 130a, and one by one between two adjacent second carbon current collectors 130b.

The first solid electrode 150a is impregnated with the first liquid electrode and disposed in the first electrode reservoir 111a. The first solid electrode 150a is surrounded and disposed by the frame 110, the first carbon current collector 130a, and the separator 120. The first solid electrode 150a includes carbon-based materials such as carbon or graphite felt, carbon cloth, carbon black, graphite powder, or graphene. The first solid electrode 150a may be formed in a porous rectangular parallelepiped shape. The first solid electrode 150a may have a thickness greater than the thickness in the height direction of the first electrode reservoir 111a, in which case it may be compressed and accommodated in the first electrode reservoir 111a. The first solid electrode 150a is in close contact with the first carbon current collector 130a and the separator 120.

The second solid electrode 150b is impregnated with the second liquid electrode and disposed in the second electrode reservoir 111b. The second solid electrode 150b is surrounded and disposed by the frame 110, the second carbon current collector 130b, and the separator 120. The second solid electrode 150b includes carbon-based materials such as carbon or graphite felt, carbon cloth, carbon black, graphite powder, or graphene. The second solid electrode 150b may be formed in a porous rectangular parallelepiped shape. The second solid electrode 150b may have a thickness greater than the thickness in the height direction of the second electrode reservoir 111b, in which case it may be compressed and accommodated in the second electrode reservoir 111b. The second solid electrode 150b is in close contact with the second carbon current collector 130b and the separator 120.

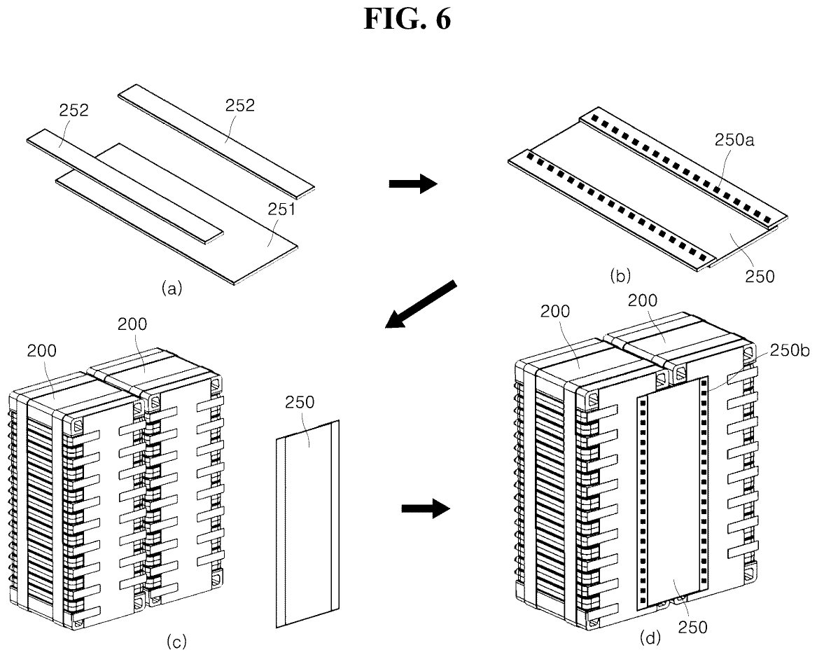

FIG. 6 is an assembly process diagram of a secondary battery according to an embodiment of the present disclosure.

Referring to (a) of FIG. 6, each of the pair of multi-busbar wings 252 is disposed on both sides of the multi-busbar body 251 so as to partially overlap.

Referring to (b) of FIG. 6, the pair of multi-busbar wings 252 are joined to both sides of the multi-busbar body 251 by spot welding 250a. Current and pressure are applied to the overlapped portion of the pair of multi-busbar wings 252 and the multi-busbar body 251. The pair of multi-busbar wings 252 have relatively thin thickness, reducing the energy consumed for spot welding.

Referring to (c) of FIG. 6, a pair of monoblocs 200 are arranged densely in the horizontal direction, and the multi-busbar 250 is disposed on the side surface of the pair of monoblocs 200.

Referring to (d) of FIG. 6, the multi-busbar 250 is joined to the pair of monoblocs 200 by spot welding 250b. Current and pressure are applied to the overlapped portion of the pair of multi-busbar wings 252 and portions of the plurality of metal current collectors 140. The pair of multi-busbar wings 252 have relatively thin thickness, reducing the energy consumed for spot welding.

As described above, the pair of multi-busbar wings 252 are joined to the plurality of multi-busbar bodies 251 and then joined to the plurality of monoblocs 200. By joining the assembled multi-busbar 250 to the plurality of monoblocs 200, parallel connection of the plurality of layers 100 of the plurality of monoblocs 200 and series connection of the plurality of monoblocs 200 can be achieved at once.

Although preferred embodiments of the present disclosure have been shown and described above, the present disclosure is not limited to the specific embodiments described above, and various modifications can be made by those of ordinary skill in the technical field to which the invention belongs without departing from the gist of the present disclosure as claimed in the claims. Such modifications should not be understood individually from the technical spirit or perspective of the present disclosure.

1. A secondary battery comprising:
a plurality of monoblocs, wherein each of the plurality of monoblocs comprises a plurality of layers stacked in one direction in which redox reactions occur; and
a multi-busbar electrically connecting the plurality of monoblocs in series and electrically connecting the plurality of layers of each of the plurality of monoblocs in parallel.

2. The secondary battery of claim 1, further comprising:
a single-busbar electrically connecting the plurality of layers of any one of the plurality of monoblocs in parallel.

3. The secondary battery of claim 2,
wherein the single-busbar and the multi-busbar are disposed on a same side surface of each of the plurality of monoblocs.

4. The secondary battery of claim 1,
wherein the plurality of layers comprises a plurality of metal current collectors through which electrons move by redox reactions, and
wherein the multi-busbar electrically connects some of the plurality of metal current collectors of each of the plurality of monoblocs.

5. The secondary battery of claim 4, further comprising:
a single-busbar electrically connecting others of the plurality of metal current collectors of each of the plurality of monoblocs which are not connected to the multi-busbar.

6. The secondary battery of claim 1,
wherein the multi-busbar is disposed on a side surface of the plurality of layers of each of the plurality of monoblocs.

7. The secondary battery of claim 6,
wherein each of the plurality of monoblocs further comprises:
a pair of end plates respectively disposed at both ends in the one direction of the plurality of layers; and
a band configured to wrap and fasten the pair of end plates and the plurality of layers, and
wherein the band is disposed on another side surface of the plurality of layers on which the multi-busbar is not disposed among the side surfaces of the plurality of layers.

8. The secondary battery of claim 1,
wherein each of the plurality of layers comprises:
a first liquid electrode where a first half reaction occurs;
a second liquid electrode where a second half reaction occurs;
a first metal current collector electrically connected to the first liquid electrode; and
a second metal current collector electrically connected to the second liquid electrode,
wherein the multi-busbar electrically connects a plurality of the second metal current collectors of one of the plurality of monoblocs, and electrically connects a plurality of the first metal current collectors of another of the plurality of monoblocs.

9. The secondary battery of claim 8, further comprising:
a single-busbar electrically connecting the plurality of first metal current collectors of the one monobloc in which the plurality of second metal current collectors are connected in parallel by the multi-busbar among the plurality of monoblocs.

10. The secondary battery of claim 1,
wherein the multi-busbar comprises:
a pair of multi-busbar wings; and
a multi-busbar body joined to the pair of multi-busbar wings, and
wherein each of the pair of multi-busbar wings connects the plurality of layers of each of the plurality of monoblocs in parallel.

11. The secondary battery of claim 10,
wherein one of the pair of multi-busbar wings is joined to one side of the multi-busbar body and another of the pair of multi-bus bar wings is joined to another side of the multi-busbar body.

12. The secondary battery of claim 10,
wherein each of the pair of multi-busbar wings has one portion overlapped and joined with the multi-busbar body, and another portion not overlapped with the multi-busbar body is joined with the plurality of layers.

13. The secondary battery of claim 10,
wherein the plurality of layers comprises a plurality of metal current collectors through which electrons move by redox reactions, and
wherein each of the pair of multi-busbar wings has one surface joined to the multi-busbar body, and has another surface joined to some of the plurality of metal current collectors.

14. The secondary battery of claim 10,
wherein the plurality of layers comprises a plurality of metal current collectors through which electrons move by redox reactions, and
wherein the metal current collectors, the multi-busbar wings, and the multi-busbar body are sequentially stacked based on any one direction.

15. The secondary battery of claim 10,
wherein the pair of multi-busbar wings is joined to the multi-busbar body and then joined to the plurality of monoblocs.
